(19) United States
(12) Patent Application Publication
(10) Pub. No.: US 2006/0004490 A1
(43) Pub. Date: Jan. 5, 2006

(54) Registration correction amount calculating apparatus for calculating amount of correction for registration inspection apparatus from registration inspection data of pattern formed on wafer

(75) Inventor: Yasuhiro Sato, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/667,789

(22) Filed: Sep. 23, 2003

(30) Foreign Application Priority Data
Apr. 3, 2003 (JP) 2003-100606(P)

(51) Int. Cl. G05B 21/00

(52) U.S. Cl. 700/266

(57) ABSTRACT

A data storage portion stores a measurement value of registration accuracy after photolithography process and a measurement value of registration accuracy after etching measured by a registration inspection apparatus. An operation portion calculates an amount of correction for the registration inspection apparatus by subtracting the measurement value of registration accuracy after etching from the measurement value of registration accuracy after photolithography process stored in data storage portion. A measurement correction portion instructs an amount of correction calculated by the operation portion to registration inspection apparatus. Therefore, even if an underlying layer is displaced through the photolithography process, the registration inspection apparatus can be controlled so as to enhance process accuracy in terms of attaining a target value.

### BACKGROUND OF THE INVENTION

1. Field of the Invention

The present invention relates to a technique for correcting registration of a pattern formed on a wafer, and in particular, to a registration correction amount calculating apparatus calculating an amount of correction for a registration inspection apparatus from registration inspection data.

2. Description of the Background Art

Registration of a pattern already formed on a wafer and a pattern on a mask to be transferred has conventionally been performed in a process of manufacturing a semiconductor. In general, registration of a pattern formed on a wafer has been controlled solely based on a condition variable in a photolithography process (a series of processes including exposure and development after a sensitizer is applied to the wafer).

In inspecting registration of the formed pattern, the pattern has been recognized as excellent in quality if a measurement result is closer to a target value, which is set in advance along with a standard value. Techniques related thereto are disclosed in Japanese Patent Laying-Open No. 11-260683, and No. 2000-323383.

An apparatus for manufacturing a semiconductor material disclosed in Japanese Patent Laying-Open No. 11-260683 uses measurement data processed previously of a step performed after an exposure step, in determining an exposure condition.

According to a method of manufacturing a semiconductor disclosed in Japanese Patent Laying-Open No. 2000-323383, alignment correction is attained in the following manner. That is, registration error in a wafer that has been subjected to exposure and development process is measured. Then, an alignment correction value is calculated from the measured registration error for storage. Among the stored alignment correction values, based on an alignment correction value of a condition common to a process condition for a wafer to be subjected to exposure and development process in the next place, alignment correction in exposing a next wafer is achieved.

In manufacturing a semiconductor, a registration position in photolithography process is displaced also by an influence other than that of the photolithography process, such as displacement of an underlying layer through CMP (Chemical Mechanical Polishing), for example. Therefore, if registration is controlled solely based on a condition variable in the photolithography process, registration of the finished pattern may significantly deviate from an ideal, target value.

In addition, registration is performed based on a projected portion and a depressed portion regarded as a marker. If this marker is not correct, for example, if the markers are not symmetrically positioned, positions of the registration marks are not correctly recognized, resulting in a significant error in registration measurement. The error may even account for 50% of allowance in process accuracy. Consequently, a pattern generated through the photolithography process deviates from the target value. In many cases, this is a problem in the photolithography process caused by a specific wafer process.

Moreover, the error, that is, deviation from the target value, is revealed only after a process that cannot be restored, such as etching. These problems cannot be solved even with the above-mentioned conventional art.

### SUMMARY OF THE INVENTION

An object of the present invention is to provide a registration correction amount calculating apparatus capable of improving process accuracy in terms of attaining a target value even if an underlying layer is displaced.

According to one aspect of the present invention, a registration correction amount calculating apparatus includes a data storage portion storing a measurement value of registration accuracy after a process in a first step and a measurement value of registration accuracy after a process in a second step measured by a registration inspection apparatus; and an operation portion calculating an amount of correction for the registration inspection apparatus from the measurement value of registration accuracy after the process in the first step and the measurement value of registration accuracy after the process in the second step stored by the data storage portion. Therefore, the registration inspection apparatus can be controlled so as to improve process accuracy in terms of attaining a target value, even if an underlying layer is displaced through the first step.

According to another aspect of the present invention, a registration correction amount calculating apparatus includes a data storage portion storing a measurement value of registration accuracy after a process in a first step and a measurement value of registration accuracy after a process in a second step measured by a registration inspection apparatus; and an operation portion calculating an amount of correction for an exposure apparatus from the measurement value of registration accuracy after the process in the first step and the measurement value of registration accuracy after the process in the second step stored by the data storage portion. Therefore, the exposure apparatus can be controlled so as to improve process accuracy in terms of attaining a target value, even if an underlying layer is displaced through the first step.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a process step in a semiconductor manufacturing system where a registration correction amount calculating apparatus in a first embodiment of the present invention is employed.

FIGS. 2A to 2D show one example of a process pattern formed by the process steps shown in FIG. 1.

FIG. 3 illustrates an outline of a process of manufacturing a semiconductor using the registration correction amount calculating apparatus in the first embodiment of the present invention.

FIG. 4 is a block diagram showing a brief configuration of the semiconductor manufacturing system where the registration correction amount calculating apparatus in the first embodiment of the present invention is employed.

FIG. 5 is a block diagram showing a configuration example of a registration correction amount calculating apparatus 3 in the first embodiment of the present invention.

FIG. 6 is a flowchart illustrating a correction process of a registration inspection apparatus 4 using registration correction amount calculating apparatus 3.

FIG. 7 is a block diagram showing a brief configuration of a semiconductor manufacturing system in a second embodiment of the present invention.

FIG. 8 shows one example of measurement points on a wafer.

### DESCRIPTION OF THE PREFERRED EMBODIMENTS

### First Embodiment

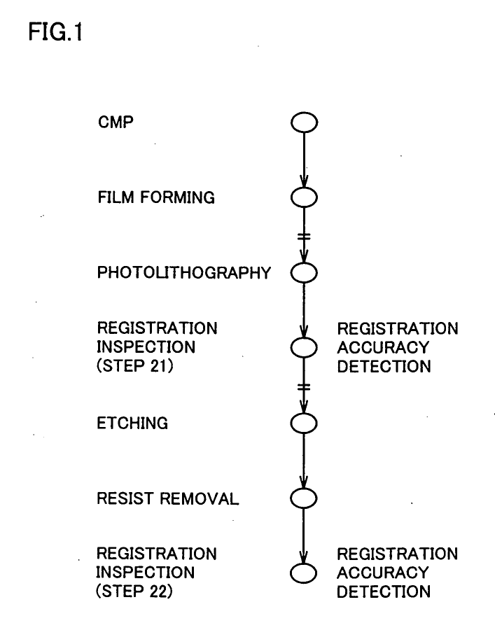

FIG. 1 schematically shows a process step in a semiconductor manufacturing system in which a registration correction amount calculating apparatus in the first embodiment of the present invention is employed. A wafer is subjected to a process such as CMP or film forming, and thereafter, it is subjected to a photolithography process (a series of processes including exposure and development, after a sensitizer is applied to the wafer). Thereafter, registration accuracy of the pattern formed on the wafer is measured (step 21). This step 21 is performed on each lot.

After the wafer is subjected to the etching process, a resist is removed. Then, registration accuracy of the pattern formed on the wafer is measured again (step 22).

Step 21 is performed for registration inspection after the pattern is subjected to the photolithography process, and step 22 is performed for inspecting finish after the series of process steps.

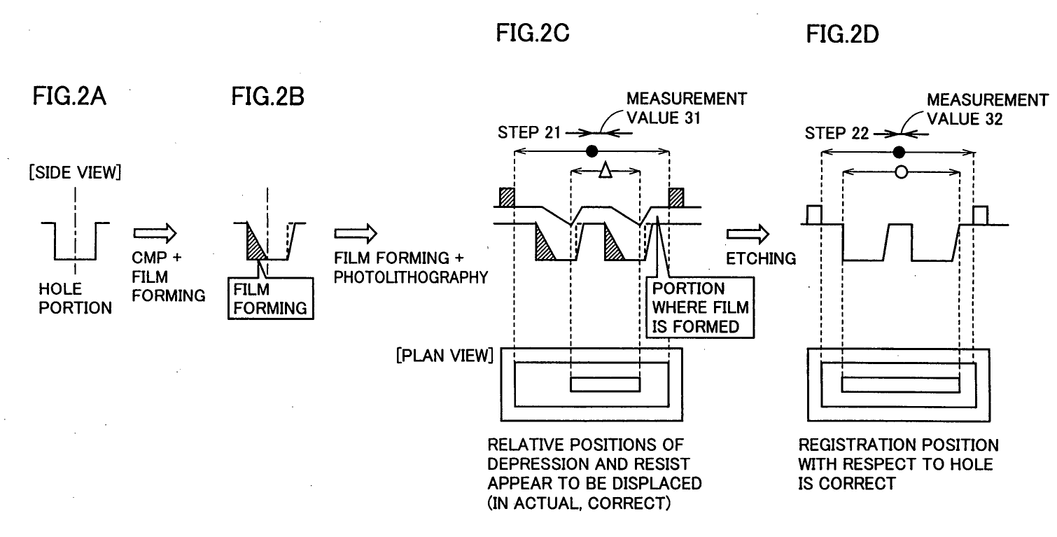

FIGS. 2A to 2D show one example of the process pattern formed by the process steps shown in FIG. 1. FIG. 2A is a side view of a hole portion formed in the wafer, and FIG. 2B shows the hole portion after the CMP process and the film-forming process.

FIG. 2C illustrates a measurement value of registration accuracy of the pattern after the film-forming process and the photolithography process. As a depression of the film portion formed over the hole portion is displaced from the hole portion (includes displacement component of the underlying layer), a measurement value 31 of registration accuracy after the photolithography process is found as a distance between a center of a position of the resist (shown with a black circle) and a center of a position of the depression (shown with an open triangle). Though the registration position of the resist with respect to the hole portion is actually correct, measurement value 31 of registration accuracy attains to a certain large value.

FIG. 2D illustrates a measurement value of registration accuracy of the pattern after the etching process. A measurement value 32 of registration accuracy after the etching process is found as a distance between a center of a position of the pattern formed by etching (shown with a black circle) and a center of a position of the hole portion (shown with an open circle). As the registration position of the resist with respect to the hole position is correct, measurement value 32 of registration accuracy attains to a relatively small value.

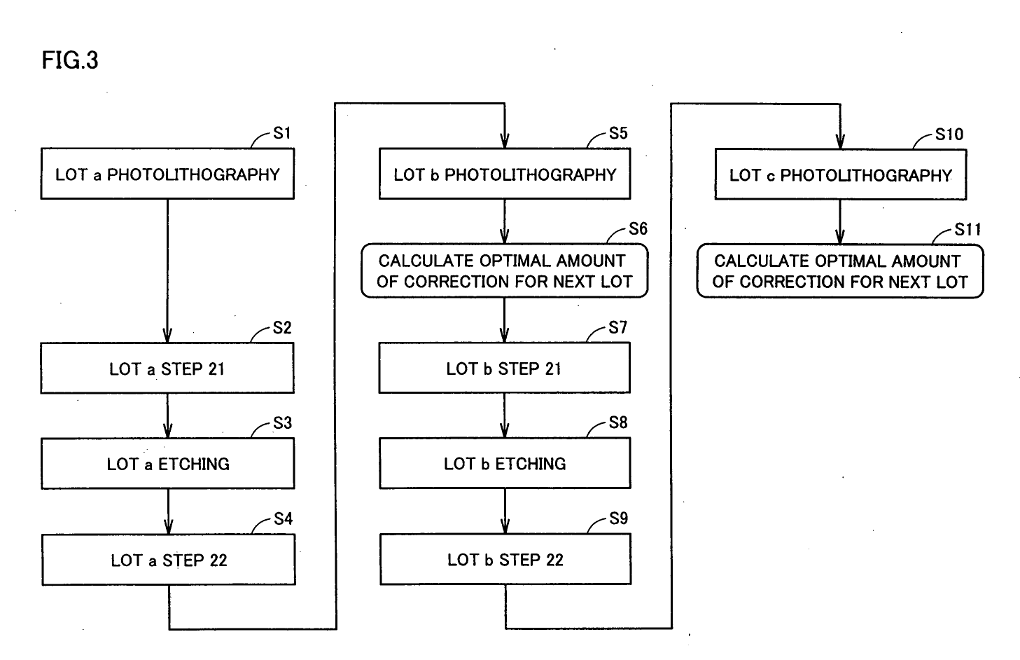

FIG. 3 illustrates an outline of a process for manufacturing a semiconductor using a registration correction amount calculating apparatus in the first embodiment of the present invention. First, a lot a is subjected to the photolithography process (S1), and to registration inspection (step 21) after the photolithography (S2). Then, lot a is subjected to the etching process (S3), and to registration inspection (step 22) after etching (S4).

Next, a lot b is subjected to the photolithography process (S5). Then, an optimal amount of registration correction 33a for a next lot (lot b) is calculated from a measurement value 31a of registration accuracy after the photolithography process and a measurement value 32a of registration accuracy after the etching process of lot a (S6), using the following equation.
(optimal amount of registration correction 33)=(measurement value 31)−(measurement value 32). (1)

Thereafter, registration accuracy of lot b is corrected, using calculated optimal amount of registration correction 33a, and lot b is subjected to registration inspection (step 21) after the photolithography process (S7). Then, lot b is subjected to the etching process (S8), and to registration inspection (step 22) after the etching process (S9).

Next, a lot c is subjected to the photolithography process (S10). Then, an optimal amount of registration correction 33b for a next lot (lot c) is calculated from a measurement value 31b of registration accuracy after the photolithography process and a measurement value 32b of registration 10 accuracy after the etching process of lot b, using equation (1). Similar steps will be repeated for a subsequent process.

In this manner, amount of registration correction 33 for a lot to be processed in the next place is calculated using previous measurement values 31 and 32 of registration accuracy for feedback. Thus, registration inspection taking into account displacement of the underlying layer or the apparatus can be attained.

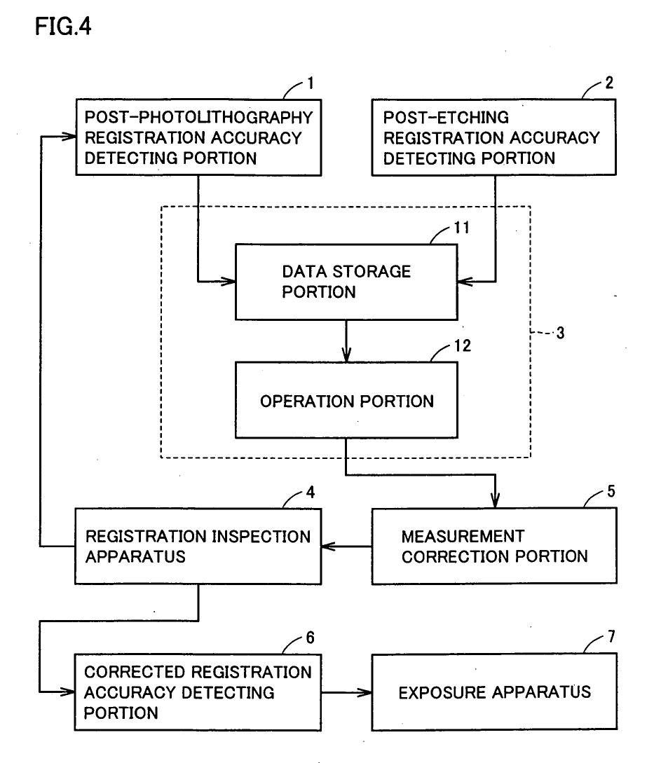

FIG. 4 is a block diagram showing a brief configuration of the semiconductor manufacturing system where the registration correction amount calculating apparatus in the first embodiment of the present invention is employed. The semiconductor manufacturing system includes: a post-photolithography registration accuracy detecting portion 1 for detecting registration accuracy found in registration inspection of each lot that has been subjected to photolithography; a post-etching registration accuracy detecting portion 2 for detecting registration accuracy found in registration inspection of each lot that has been subjected to etching; a registration correction amount calculating apparatus 3; a registration inspection apparatus 4; a measurement correction portion 5 correcting registration inspection apparatus 4, using an optimal amount of registration correction calculated by registration correction amount calculating apparatus 3; a corrected registration accuracy detecting portion 6 detecting registration accuracy (corrected registration accuracy) measured by registration inspection apparatus 4, taking into account the optimal amount of registration correction; and an exposure apparatus 7 correcting exposure using the corrected registration accuracy detected by corrected registration accuracy detecting portion 6.

Registration correction amount calculating apparatus 3 includes: a data storage portion 11 storing measurement value 31 of registration accuracy after the photolithography process detected by post-photolithography registration accuracy detecting portion 1 and measurement value 32 of registration accuracy after the etching process detected by post-etching registration accuracy detecting portion 2; and an operation portion 12 calculating optimal amount of registration correction 33 from measurement value 31 of registration accuracy after the photolithography process and measurement value 32 of registration accuracy after the etching process stored in data storage portion 11.

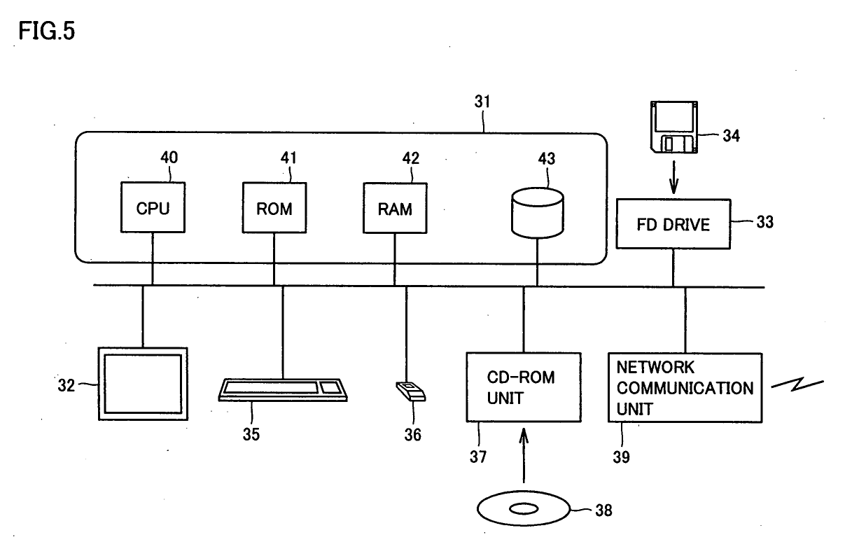

FIG. 5 is a block diagram showing a configuration example of registration correction amount calculating apparatus 3 in the first embodiment of the present invention. Registration correction amount calculating apparatus 3 includes a computer unit 31, a display unit 32, an FD (Flexible Disk) drive 33 having an FD 34 mounted, a keyboard 35, a mouse 36, a CD-ROM (Compact Disc-Read Only Memory) unit 37 having a CD-ROM 38 mounted, and a network communication unit 39.

A program for calculating an amount of registration correction is supplied by a medium such as FD 34 or CD-ROM 38. When the program for calculating an amount of registration correction is executed by computer unit 31, the optimal amount of registration correction is calculated. Alternatively, the program for calculating an amount of registration correction may be supplied to computer unit 31 via network communication unit 39 from other computers.

Computer unit 31 shown in FIG. 5 includes a CPU (Central Processing Unit) 40, an ROM (Read Only Memory) 41, an RAM (Random Access Memory) 42, and a hard disk 43. CPU 40 performs processes, by inputting/outputting data to/from display unit 32, FD drive 33, keyboard 35, mouse 36, CD-ROM unit 37, network communication unit 39, ROM 41, RAM 42, or hard disk 43.

The program for calculating an amount of registration correction recorded in FD 34 or CD-ROM 38 is once stored in hard disk 43 via FD drive 33 or CD-ROM unit 37 by CPU 40. CPU 40 loads the program for calculating an amount of registration correction from hard disk 43 to RAM 42 for execution as required, whereby calculation of the amount of registration correction is attained.

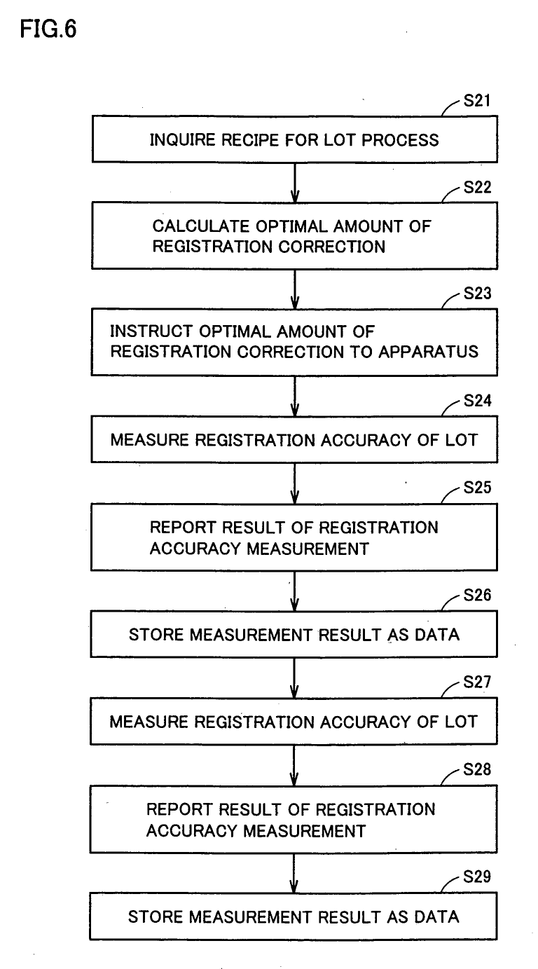

FIG. 6 is a flowchart illustrating a correction process of registration inspection apparatus 4 using registration correction amount calculating apparatus 3. First, registration correction amount calculating apparatus 3 inquires a recipe for processing a lot (S21). A not-shown manufacture administration apparatus or the like administers which lot is currently in process, and this information is obtained by registration correction amount calculating apparatus 3.

Then, referring to the recipe for the lot process, operation portion 12 reads measurement value 31 of registration accuracy after the photolithography process and measurement value 32 of registration accuracy after etching from data storage portion 11 detected through the previous lot process, and calculates an optimal amount of registration correction, using equation (1) (S22).

Next, measurement correction portion 5 instructs the optimal amount of registration correction calculated by operation portion 12 to registration inspection apparatus 4 (S23). Registration inspection apparatus 4 performs registration inspection after the photolithography process using the optimal amount of registration correction instructed by measurement correction portion 5 (S24), and reports a measurement result of registration accuracy after the photolithography process to post-photolithography registration accuracy detecting portion 1 (S25). Data storage portion 11 obtains and stores measurement value 31 of registration accuracy after photolithography process from post-photolithography registration accuracy detecting portion 1 (S26).

Then, registration inspection apparatus 4 performs registration inspection after etching (S27), and reports a measurement result of registration accuracy after etching to post-etching registration accuracy detecting portion 2 (S28). Data storage portion 11 obtains and stores measurement value 32 of registration accuracy after etching from post-etching registration accuracy detecting portion 2 (S29).

The series of processes as above are performed with respect to each lot, each step and each apparatus, and displacement of the underlying layer or the like is continuously corrected. Therefore, registration accuracy in terms of attaining the target value can be enhanced, and process quality in a product can be improved.

In addition, when there are a plurality of lots that went through measurement of registration accuracy after the photolithography process and registration accuracy after etching, for example, when lot a and lot b are present, an optimal amount of registration correction for lot c may be calculated using the following equation.
(optimal amount of registration correction for lot c)=operation (optimal amount of registration correction for lot a 33a, optimal amount of registration correction for lot b 33b). (2)

Here, as an operation, average or center is used, for example, and the number of pieces of data to be used for the operation is separately specified in advance.

Corrected registration accuracy detecting portion 6 detects a corrected registration result measured by registration inspection apparatus 4. The corrected registration result measured by registration inspection apparatus 4 is expressed in an equation below.
(corrected registration result)=(registration measurement result after the photolithography process)−(optimal amount of registration correction). (3)

Corrected registration accuracy detecting portion 6 corrects exposure apparatus 7, using the corrected registration result measured by registration inspection apparatus 4.

As described above, according to a registration correction amount calculating apparatus in the present embodiment, an optimal amount of registration correction is calculated from the previous measurement value of registration accuracy after photolithography process and the previous measurement value of registration accuracy after the etching process. Therefore, even if displacement of the underlying layer or the like takes place, process accuracy in terms of attaining the target value can be improved.

In addition, conditioning for re-determining an optimal amount of registration correction (a preceding pilot process before a process) is not necessary, and an optimal amount of registration correction can be obtained without causing delay in manufacture, thereby reducing a manufacturing time. Further, a wafer for conditioning (a wafer to be used for the preceding pilot process) is not needed, and waste of the wafer can be avoided.

### Second Embodiment

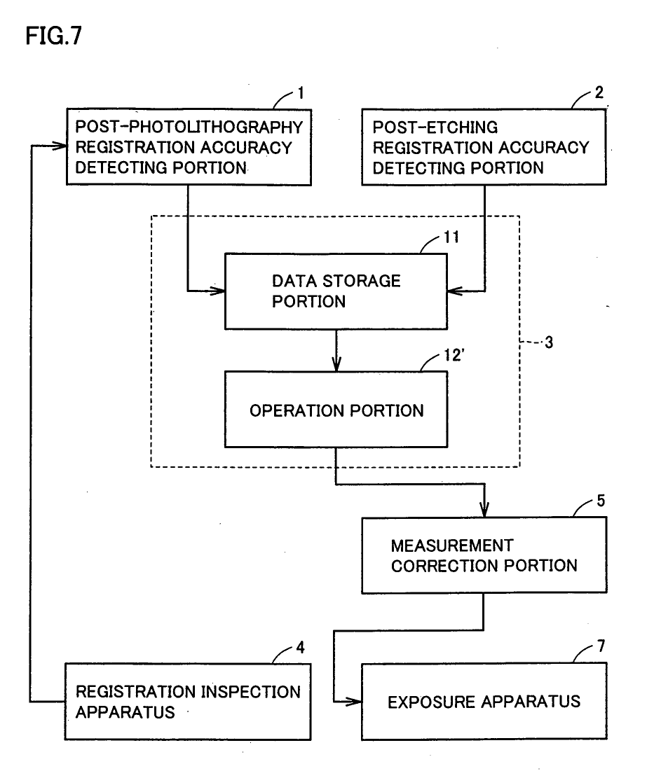

FIG. 7 is a block diagram showing a brief configuration of a semiconductor manufacturing system in a second embodiment of the present invention. The present semiconductor manufacturing system is different from that shown in FIG. 4 only in that the operation portion calculates a corrected registration result, and that measurement correction portion 5 uses the corrected registration result to correct exposure apparatus 7. Therefore, detailed description of redundant configuration and function will not be repeated. It is to be noted that the operation portion in the present embodiment is represented with reference numeral 12′.

In the first embodiment, registration inspection apparatus 4 uses an optimal amount of registration correction to measure registration accuracy after the photolithography process, and outputs the measurement value of the registration accuracy (corrected registration measurement result) to corrected registration accuracy detecting portion 6. On the other hand, in the present embodiment, an operation portion 12′ calculates a corrected registration result from registration measurement value 31 after the photolithography process and optimal amount of registration correction 33, using the next equation.
(corrected registration result)=(registration measurement result 31 after the photolithography process of a currently-measured lot)−(optimal amount of registration correction 33 of a previous lot). (4)

Measurement correction portion 5 uses the corrected registration result calculated by operation portion 12′ to correct exposure apparatus 7.

As described above, according to the registration correction amount calculating apparatus in the present embodiment, operation portion 12′ calculates a corrected registration result from registration measurement value 31 after the photolithography process and optimal amount of registration correction 33. Therefore; even if registration inspection apparatus 4 without a function to use optimal amount of registration correction 33 for correction is employed, an effect as described in the first embodiment can be obtained.

### Third Embodiment

Brief configuration of a semiconductor manufacturing system in the third embodiment of the present invention is similar to those in the first and second embodiments shown in FIGS. 4 and 7, and therefore, detailed description of redundant configuration and function will not be repeated. In addition, as a procedure for correction process in registration inspection apparatus 4 in the present embodiment is similar to that in the first embodiment shown in FIG. 6, detailed description thereof will not be repeated.

There exist a plurality of categories required in forming a pattern on a wafer, such as wafer offset, wafer rotation, wafer scaling or the like in registration. In the present embodiment, a category for calculating an optimal amount of registration correction is selected. A plurality of categories may be selected. For example, if wafer offset and wafer rotation are selected, the correction process described in the first or second embodiment is performed in parallel to respective categories. Each category is independently handled.

As described above, according to the semiconductor manufacturing system in the present embodiment, a category for calculating an optimal amount of registration correction is selected. Therefore, the correction process can be performed solely on a category which is desirably brought closer to the target value.

### Fourth Embodiment

Brief configuration of a semiconductor manufacturing system in the fourth embodiment of the present invention is similar to those in the first and second embodiments shown in FIGS. 4 and 7, and therefore, detailed description of redundant configuration and function will not be repeated. In addition, as a procedure for correction process in registration inspection apparatus 4 in the present embodiment is similar to that in the first embodiment shown in FIG. 6, detailed description thereof will not be repeated.

In the semiconductor manufacturing system in the present embodiment, measurement value for each category is not limited to one from a lot. On the other hand, registration accuracy is measured at each point on a wafer and a shot respectively, and results are reported to registration correction amount calculating apparatus 3.

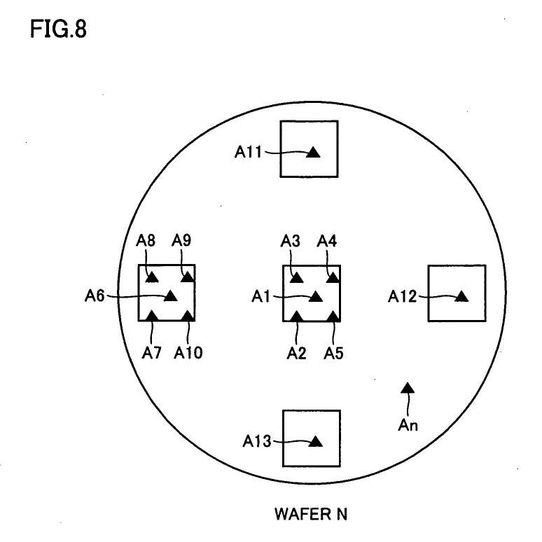

FIG. 8 shows one example of measurement points on a wafer. In FIG. 8, Al to An represent measurement results at respective points, and an optimal amount of registration correction is calculated in a manner as described in the first or second embodiment. Thus, registration accuracy at each point on a shot or a wafer is measured, and an optimal amount of registration correction is calculated for each lot, each wafer, or each shot as required, for correction process. Here, calculation of an optimal amount of registration correction is performed with equation (1).

As described above, according to the semiconductor manufacturing system in the present embodiment, an optimal amount of registration correction is calculated for each lot, each wafer, or each shot. Therefore, a point which is desirably brought closer to the target value can be set finely, and correction process can be performed solely on that point.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A registration correction amount calculating apparatus, comprising:
a data storage portion storing a measurement value of registration accuracy after a process in a first step and a measurement value of registration accuracy after a process in a second step measured by a registration inspection apparatus; and
an operation portion calculating an amount of correction for said registration inspection apparatus from the measurement value of registration accuracy after the process in the first step and the measurement value of registration accuracy after the process in the second step stored by said data storage portion.

2. The registration correction amount calculating apparatus according to claim 1, wherein
said operation portion calculates the amount of correction for said registration inspection apparatus by subtracting the measurement value of registration accuracy after the process in the second step from the measurement value of registration accuracy after the process in the first step.

3. The registration correction amount calculating apparatus according to claim 1, wherein
said operation portion calculates the amount of correction for said registration inspection apparatus with respect to a current lot from the measurement value of registration accuracy of a previous lot after the process in the first step and the measurement value of registration accuracy of the previous lot after the process in the second step.

4. The registration correction amount calculating apparatus according to claim 1, wherein
said first step represents a photolithography process, and said second step represents an etching process.

5. A registration correction amount calculating apparatus, comprising:
a data storage portion storing a measurement value of registration accuracy after a process in a first step and a measurement value of registration accuracy after a process in a second step measured by a registration inspection apparatus; and
an operation portion calculating an amount of correction for an exposure apparatus from the measurement value of registration accuracy after the process in the first step and the measurement value of registration accuracy after the process in the second step stored by said data storage portion.

6. The registration correction amount calculating apparatus according to claim 5, wherein
said operation portion calculates an optimal amount of registration correction by subtracting the measurement value of registration accuracy of a previous lot after the process in the second step from the measurement value of registration accuracy of the previous lot after the process in the first step, and calculates an amount of correction for said exposure apparatus by subtracting said optimal amount of registration correction from the measurement value of registration accuracy of a current lot after the process in the first step.

7. The registration correction amount calculating apparatus according to claim 5, wherein
said first step represents a photolithography process, and said second step represents an etching process.
